(19) United States
(12) Patent Application Publication
(10) Pub. No.: US 2011/0202670 A1
(43) Pub. Date: Aug. 18, 2011

(54) METHOD, DEVICE AND SYSTEM FOR IDENTIFYING IP SESSION

(75) Inventor: Ruobin Zheng, Shenzhen (CN)

(73) Assignee: Huawei Technologies Co., Ltd., Shenzhen (CN)

(21) Appl. No.: 13/097,369

(22) Filed: Apr. 29, 2011

Related U.S. Application Data
(63) Continuation of application No. PCT/CN2009/074628, filed on Oct. 27, 2009.

(30) Foreign Application Priority Data
Oct. 31, 2008 (CN) 200810172313.X

(51) Int. Cl. G06F 15/16

(52) U.S. Cl. 709/228

(57) ABSTRACT

A method, a device, and a system for identifying an Internet Protocol (IP) session are provided. The method includes: a network gateway generates an IP session identity (ID) for an IP session during an IP address configuration process for a user equipment (UE), according to preset rules for generating the IP session ID; and filters a received IP session packet from the UE according to the IP session ID. By applying the technical solutions, a coupling relation between a data communication process and an authentication process or an IP address configuration process of the IP session is established, and the security of the IP session is enhanced.

### CROSS-REFERENCE TO RELATED APPLICATIONS

This application is a continuation of International Application No. PCT/CN2009/074628, filed on Oct. 27, 2009, which claims priority to Chinese Patent Application No. 200810172313.X, filed on Oct. 31, 2008, both of which are hereby incorporated by reference in their entireties.

### TECHNICAL FIELD

The present invention relates to the field of communications technologies, and in particular, to a method, a device, and a system for identifying an Internet Protocol (IP) session.

### BACKGROUND

In an access network, an IP session represents a network access connection session associated with an IP address of a subscriber or user equipment, and the IP session is similar to a Point-to-Point Protocol (PPP) session (PPP session). The IP session and the PPP session are collectively referred to as subscriber sessions. The PPP session adopts a specific PPP keepalive detection mechanism, and the IP version 4 (IPv4) session adopts a specific Bidirectional Forwarding Detection (BFD)/Address Resolution Protocol (ARP) keepalive detection mechanism.

The IP session is generally terminated at an IP edge device, for example, a Broadband Network Gateway (BNG) or Broadband Remote Access Server (BRAS), and the other side of the IP session is generally terminated at a user equipment (UE), for example, a Home Gateway (HGW) or a user terminal equipment after the HGW, that is, the IP session is a session connection established between the UE and the IP edge device.

The IP session is used for the management of a network when a subscriber accesses the network, such as, accounting and state.

During the implementation of the present invention, the inventor finds that the prior art at least has the following problems:

The data communication process is separated with the authentication process or the IP address configuration process of the IP session in the prior art, so an attacker may impersonate an valid sender by forging an IP address or a Media Access Control (MAC) address during the data communication process of the IP session even if the authentication is passed, causing high risks to the security.

### SUMMARY

Embodiments of the present invention provide a method, a device, and a system for identifying an IP session, capable of filtering an IP session by checking whether an IP session identity (ID) generated according to preset rules is added into the IP session, so that a coupling relation between a data communication process and an authentication process or an IP address configuration process of the IP session is established, and the security of the IP session is enhanced.

In order to achieve the above objective, in one aspect, an embodiment of the present invention provides a method for identifying an IP session, where the method includes:

generating an IP session ID for an IP session during an authentication process and/or IP address configuration process, according to preset rules for generating the IP session ID; and

filtering a received IP session packet according to the IP session ID.

In another aspect, an embodiment of the present invention also provides a network gateway, where the network gateway includes:

a generating module, configured to generate an IP session ID for an IP session during an authentication process and/or IP address configuration process, according to preset rules for generating the IP session ID; and

a processing module, configured to filter a received IP session packet according to the IP session ID.

In another aspect, an embodiment of the present invention further provides a system for processing an IP session, where the system includes a UE and a network gateway,

the UE is configured to receive rules for generating an IP session ID sent by the network gateway, generate the corresponding IP session ID according to the rules for generating the IP session ID, and send an IP session packet to the network gateway; and

the network gateway is configured to set the rules for generating the IP session ID, send the rules for generating the IP session ID to the UE, generate the IP session ID for an IP session during an authentication process or an IP address configuration process according to the rules for generating the IP session ID, and filter the IP session according to the IP session ID.

The technical solutions according to the embodiments of the present invention have the following advantages: a method for filtering an IP session is implemented by checking whether an IP session ID generated according to preset rules is added into the IP session, so that a coupling relation between a data communication process and an authentication process or an IP address configuration process of the IP session is established, and the security of the IP session is enhanced.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a schematic flow chart of a method for identifying an IP session according to Embodiment 1 of the present invention;

FIG. 2 is a schematic flow chart of a method for identifying an IP session according to Embodiment 1 of the present invention;

FIG. 3 is a schematic structural diagram of a system for processing an IP session according to Embodiment 2 of the present invention;

FIG. 4 is a schematic flow chart of a method for identifying an IP session in a dynamic IPv6 session according to Embodiment 3 of the present invention;

FIG. 5 is a schematic flow chart of another method for identifying an IP session in a dynamic IPv6 session according to Embodiment 4 of the present invention;

FIG. 6 is a schematic flow chart of another method for identifying an IP session in a dynamic IPv6 session according to Embodiment 5 of the present invention;

FIG. 7 is a schematic flow chart of another method for identifying an IP session in a dynamic IPv6 session according to Embodiment 6 of the present invention;

FIG. 8 is a schematic flow chart of another method for identifying an IP session in a dynamic IPv6 session according to Embodiment 7 of the present invention; and

FIG. 9 is a schematic flowchart of a method for identifying an IP session in a static IPv6 session according to Embodiment 8 of the present invention.

### DETAILED DESCRIPTION

Embodiments of the present invention provide a method, a device, and a system for identifying an IP session. The technical solution includes the following content: An IPv6 session ID field is set in an IPv6 flow label, or an IPv6 session ID field (for example, an IPv6 address prefix) is set in an IPv6 address. After a subscriber authentication or an IP address configuration process succeeds, an IPv6 session ID is generated according to rules agreed by the subscriber and the operator, to realize coupling of the IPv6 session with the authentication process or with the IP address configuration process.

The IPv6 session ID remains unchanged during a keepalive process of the IP session, a BNG filters the received data packet according to the IPv6 session ID, to effectively prevent an attacker from impersonating a valid sender by forging an IP address or a MAC address. Therefore, the security of shared medium access is ensured.

The technical solutions of the present invention will be clearly and completely described in the following with reference to the accompanying drawings. It is obvious that the embodiments to be described are only a part rather than all of the embodiments of the present invention. All other embodiments obtained by persons skilled in the art based on the embodiments of the present invention without creative efforts shall fall within the protection scope of the present invention.

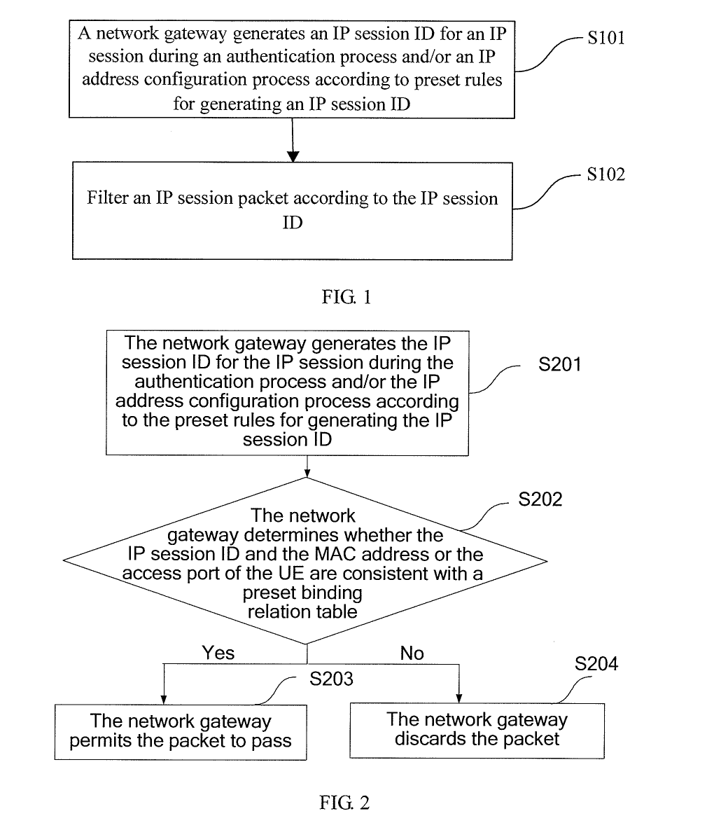

FIG. 1 is a schematic flow chart of a method for identifying an IP session according to Embodiment 1 of the present invention. Referring to FIG. 1, the method includes the following steps.

In step S101, a network gateway generates an IP session ID for an IP session during an authentication process and/or an IP address configuration process according to preset rules for generating the IP session ID.

Specifically, for ease of description, an IPv6 session is taken as an example in the embodiments of the present invention. However, it should be noted that, other sessions satisfying the requirements for implementation scenarios of the embodiments of the present invention also fall within the protection scope of the present invention, which is applicable through the specification, so the details will not be describe herein again.

The IPv6 sessions are classified into dynamic IPv6 sessions and static IPv6 sessions.

The dynamic IPv6 sessions may be dynamically established and terminated, and the static IPv6 sessions may only be statically configured and generated.

The technical solution of the embodiment of the present invention includes setting an IPv6 session ID field in an IPv6 flow label, or setting an IPv6 session ID field (for example, an IPv6 address prefix) in an IPv6 address. As for a dynamic IP session, an IP session ID may be generated for the IP session during the authentication process and the IP address configuration process, which includes: performing mapping to the IPv6 session ID field of the IPv6 Flow label according to agreed rules through an authentication session ID and a Dynamic Host Configuration Protocol Transaction ID (DHCP Transaction ID, xid), to generate an IPv6 session ID. As for the dynamic IP session, an IP session ID may also be generated for the IP session during the authentication process and the IP address configuration process, which includes: mapping an IPv6 address prefix of a Subscriber obtained through DHCP Prefix Delegation (PD) or StateLess Address AutoConfiguration (SLAAC) according to agreed rules to serve as an IPv6 session ID, that is, binding the IPv6 address prefix of the Subscriber and the IPv6 session. As for a static IP session, an IPv6 session ID may be generated according to agreed rules and according to an IPv6 address/IPv6 address prefix.

Based on the IPv6 session ID (for example, the IPv6 address prefix), an IP edge node may authorize the IPv6 session according to the IPv6 session ID, in which the authorization of the IPv6 session is generally implemented by using an Authentication, Authorization and Accounting (AAA) Protocol, and the IPv6 session ID (for example, the IPv6 address prefix) may be carried in an AAA message of the IPv6 session.

As for the dynamic IPv6 session, the rules for generating the IPv6 session ID may be dynamically configured onto a UE before the IPv6 session is set up, or is dynamically configured onto the UE through an authentication protocol/DHCP after the authentication/IP address configuration succeeds; as for the static IPv6 session, the rules for generating the IPv6 session ID may be configured statically, that is, before step S101, the following two situations exist:

When the IP session is a dynamic IP session, the rules for generating the IP session ID are set in the network gateway, and the rules for generating the IP session ID are set in the UE by sending an authentication acknowledgement message or an address configuration response message to the UE.

When the IP session is a static IP session, the rules for generating the IP session ID are set in the network gateway and the UE.

Corresponding to the two situations, the content of step S101 is classified into the following two situations:

When the IP session is the dynamic IP session, the IP session ID is generated for the IP session during the authentication process and/or the IP address configuration process according to the preset rules for generating the IP session ID, and according to an IP session address prefix obtained through address configuration PD or Router Advertisement (RA), an authentication identifier in the authentication acknowledgement message, or a transaction ID in the address configuration response message.

When the IP session is the static IP session, the IP session ID is generated for the IP session during the IP address configuration process according to the preset rules for generating the IP session ID and according to an IP session address or an IP session address prefix preset in the UE.

It should be further noted that, when the IP session is the dynamic IP session, after generating the IP session ID according to the transaction ID in the address configuration response message, the method further includes the following step:

When an IP address configuration result of the IP session is updated, an updated IP session ID is generated for the IP session according to the preset rules for generating the IP session ID and according to the transaction ID in an updated address configuration response message.

The IPv6 session ID remains unchanged during a keepalive process of the IP session.

The IPv6 session is identified by the IPv6 session ID.

In step S102, filter a received IP session packet according to the IP session ID.

Furthermore, when the IP session is a dynamic IP session, the method further includes the following step:

Release the IP session ID when the IP session is terminated.

Furthermore, in specific application environment, as shown in FIG. 2, step S102 may include the following steps.

In step S201, the network gateway generates the IP session ID for the IP session during the authentication process and/or the IP address configuration process according to the preset rules for generating the IP session ID.

The content of this step is the same as that in step S101, so the details will not be describe herein again.

In step S202, the network gateway determines whether the IP session ID and a MAC address or access port of the UE are consistent with a preset binding relation table.

In this step, the network gateway determines whether the corresponding relation between the MAC address or the access port of the UE and the IP session ID is consistent with information in the preset binding relation table, and determines whether a packet of a received IP session is from a preset MAC address or access port, that is, determines whether the IP session is an IP session initiated by an authenticated port and satisfying authentication requirements.

The binding relation table is a binding relation table of the IP session ID and the MAC address or the access port of the UE generated when the UE completes the authentication.

The access port may be an access physical port (for example, a digital subscriber line port or a Passive Optical Network physical interface) or an access logical port (for example, a Virtual Local Area Network (VLAN) port or a Gigabit Passive Optical Network encapsulation mode port).

If the network gateway determines that the IP session ID and the MAC address or the access port of the UE are consistent with the preset binding relation table, step S203 is performed.

If the network gateway determines that the IP session ID and the MAC address or the access port of the UE are not consistent with the preset binding relation table, step S204 is performed.

In step S203, the network gateway permits the packet to pass.

That is, the UE that sends the packet is an authenticated UE, the packet is secure, and the packet is permitted to pass.

In step S204, the network gateway discards the packet.

That is, the UE that sends the packet is not an authenticated UE, and as the security of the packet is unknown, the packet is discarded.

Furthermore, when the IP session is a dynamic IP session, the method further includes the following step:

Release the IP session ID when the IP session is terminated.

The technical solution according to the embodiment of the present invention has the following advantages: the method for filtering the IP session is implemented by checking whether the IP session ID generated according to the preset rules is added into the IP session, so that a coupling relation between a data communication process and an authentication process or an IP address configuration process of the IP session is established, and the security of the IP session is enhanced.

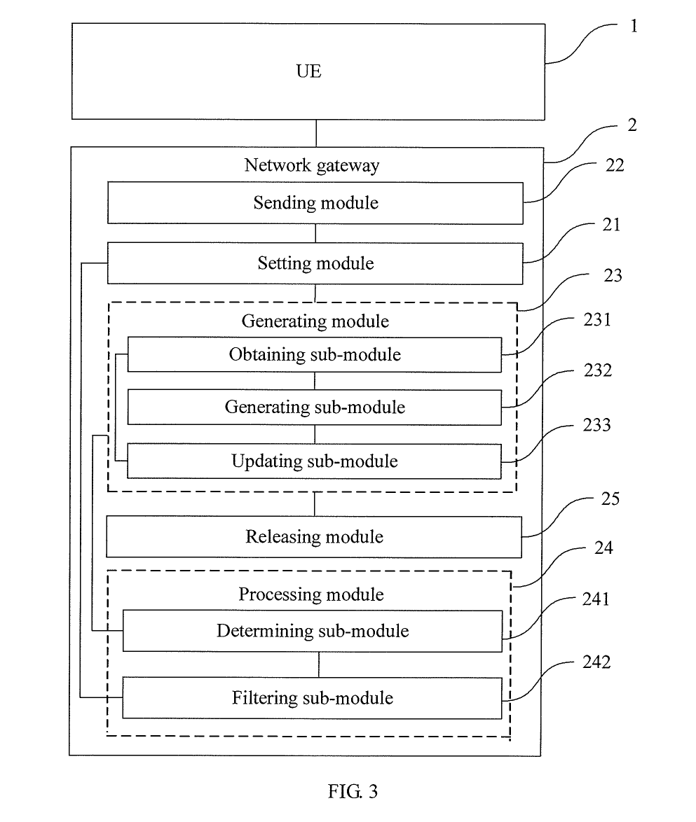

Corresponding to the technical solution of Embodiment 1 of the present invention, Embodiment 2 of the present invention provides a system for processing an IP session. FIG. 3 is a schematic structural diagram of a system for processing an IP session according to Embodiment 2 of the present invention. Referring to FIG. 3, the system includes a UE 1 and a network gateway 2.

The UE 1 is configured to receive the rules for generating the IP session ID sent by the network gateway 2, generate the corresponding IP session ID according to the rules for generating the IP session ID, and send the IP session packet to the network gateway 2. Furthermore, the UE 1 is also configured to set the IP session address or the IP session address prefix, to provide reference information for generating the IP session ID.

The network gateway 2 is configured to set the rules for generating the IP session ID, send the rules for generating the IP session ID to the UE 1, generate the IP session ID for the IP session during the authentication process and/or the IP address configuration process according to the rules for generating the IP session ID, and filter the IP session according to the IP session ID. The network gateway 2 includes a setting module 21, a sending module 22, a generating module 23, a processing module 24, and a releasing module 25.

The setting module 21 is configured to set the rules for generating the IP session ID and the binding relation table in the network gateway 2.

The sending module 22 is configured to send the rules for generating the IP session ID set by the setting module 21 to the UE 1, so that the UE 1 sets the rules for generating the IP session ID.

The generating module 23 is configured to generate the IP session ID for the IP session during the authentication process and/or IP address configuration process according to the rules for generating the IP session ID preset by the setting module 21. The generating module includes an obtaining sub-module 231, a generating sub-module 232, and an updating sub-module 233.

The obtaining sub-module 231 is configured to obtain the IP session address prefix through the address configuration PD or the RA, obtain the authentication identifier in the authentication acknowledgement message, obtain the transaction ID in the address configuration response message, or obtain the IP session address or the IP session address prefix preset in the UE 1.

The generating sub-module 232 is configured to generate the IP session ID for the IP session according to the IP session address prefix, the authentication identifier, the transaction ID, or the IP session address or the IP session address prefix preset in the UE 1 obtained by the obtaining sub-module 231 and according to the rules for generating the IP session ID preset by the setting module 21.

The updating sub-module 233 is configured to generate an updated IP session ID for the IP session according to the rules for generating the IP session ID preset by the setting module 21 and according to the transaction ID in the updated address configuration response message obtained by the obtaining sub-module 231, when the IP address configuration result of the IP session is updated.

The processing module 24 is configured to filter the received IP session packet according to the IP session ID.

The processing module 24 may include a determining sub-module 241 and a filtering sub-module 242.

The determining sub-module 241 is configured to determine whether the IP session ID and the MAC address or the access port of the UE 1 are consistent with the binding relation table set by the setting module 21.

The filtering sub-module 242 is configured to permit the packet to pass, if the determining sub-module 241 determines that the IP session ID and the MAC address or the access port of the UE 1 are consistent with the preset binding relation table; and discard the packet, if the determining sub-module 241 determines that the IP session ID and the MAC address or the access port of the UE 1 are not consistent with the preset binding relation table.

The releasing module 25 is configured to release the IP session ID generated by the generating module 23 when the IP session is terminated.

The modules may be distributed in a device, or distributed in multiple devices. The modules may be combined into one module, or may be further disassembled into multiple sub-modules.

The technical solution according to the embodiment of the present invention has the following advantages: the system for filtering the IP session is implemented by checking whether the IP session ID generated according to the preset rules is added into the IP session, so that the IP session establishes the coupling relation during the data communication process and the authentication process/IP address configuration process, and the security of the IP session is enhanced.

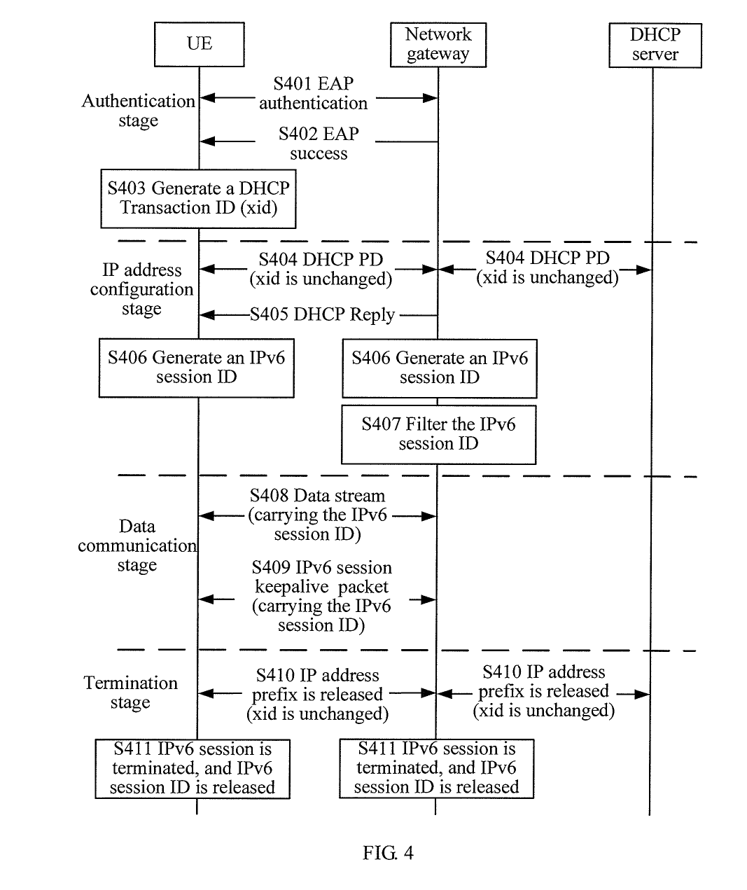

Corresponding to the technical solution of Embodiment 1 of the present invention, Embodiment 3 of the present invention provides a method for identifying an IP session in a dynamic IPv6 session, in which the IP session ID is created in an authentication stage. FIG. 4 is a flow chart of the method. Referring to FIG. 4, the method includes the following steps:

In step S401, the User/Subscriber Equipment (UE) performs the Extensible Authentication Protocol (EAP) authentication on an authentication server through the BNG.

The BNG is the network gateway described in the previous embodiments of the present invention, and the UE is a Subscriber in the specific application environment. Specifically, the UE may be an access subscriber terminal, or a network access device connected to multiple terminals such as an HGW, which is the same in the subsequent embodiments, the details will not be described in the subsequent embodiments again, and different names do not influence the protection scope of the present invention.

In step S402, when the EAP authentication of the UE succeeds, an EAP Success message is sent to the UE by the authentication server through the BNG, and the rules for generating the IPv6 session ID is configured in the UE corresponding to the subscriber.

In step S403, after the EAP authentication of the UE succeeds, the UE starts DHCP PD, and generates a DHCP Transaction ID (referred to as xid in short). The UE may generate the xid according to certain rules and according to an EAP Identifier of the EAP Success message, and if the Protocol for carrying Authentication for Network Access (PANA) is adopted, the UE may generate the xid according to certain rules and according to a PANA session ID.

In step S404, the UE requests an IPv6 address prefix through the DHCP PD, and during the IPv6 address PD process, the xid of all the DHCP messages remains unchanged.

It should be noted that, as the session ID negotiation process like PPP is not carried out before the DHCP PD process, the xid is deemed as equivalent to the IP session ID and remains consistent in the life cycle of the same IP session; and if the IPv6 address prefix renumbering is performed for the UE, it is considered that an old IP session is updated to a new IP session, and the xid will change with the new IP session.

In step S405, when the IPv6 address PD succeeds, the DHCP server sends the IPv6 address prefix to the UE through a DHCP Reply message.

In step S406, the BNG and the UE may take the IPv6 address prefix delegated by the DHCP Reply message as the IPv6 session ID.

That is to say, the IPv6 address prefix and the IPv6 session are bound; furthermore, the IPv6 session ID and the MAC address or the access port of the UE are bound to form a binding relation table.

It should be noted that, if the IPv6 address prefix renumbering is performed on the UE, it is considered that an old IP session is updated to a new IP session, and the IP session ID will be triggered by a new DHCP Reply message and generated with the new IPv6 address prefix renumbering.

In step S407, the BNG filters the IPv6 session ID of the received IPv6 packet.

The BNG filters the packet of the IP session according to the preset binding relation of the IPv6 session ID and the MAC address or the access port of the UE, that is, the BNG determines whether the received IP session packet is from the preset MAC address or the access port by checking the preset binding relation table.

When the network gateway determines that the received IP session packet is from the preset MAC address or access port, it is determined that the UE that sends the packet is an authenticated UE, and the BNG permits the packet sent by the UE to pass.

When the network gateway determines that the received IP session packet is not from the preset MAC address or access port, the BNG discards the packet.

Accordingly, when it is determined that the UE that sends the packet is not an authenticated UE, the BNG directly discards the packet. It should be further noted that, in the following embodiments, the process of the BNG filtering the IPv6 session ID of the received IPv6 packet is the same as this step, and the details will not be described again herein.

In step S408, data communication is performed by using the data stream carrying the IPv6 session ID.

In the data communication stage, the IPv6 data packets all carry the IPv6 session ID generated according to the rules for generating an IPv6 session ID determined after the authentication succeeds.

In step S409, data communication state keepalive monitoring is performed by using a keepalive packet carrying the IPv6 session ID.

The keepalive packets (for example, the BFD packets) of the IPv6 session all carry the IPv6 session ID generated according to the rules for generating the IPv6 session ID determined after the authentication succeeds.

It should be noted that, in a specific implementation environment, step S408 and step S409 have no certain sequence relation, and the change in the sequence of the two steps does not influence the protection scope of the present invention.

In step S410, the IPv6 address prefix is released or renumbered.

When the IPv6 address prefix is released or renumbered, it is considered that an old IP session is updated to a new IP session, that is, it is determined that the current IPv6 session is terminated.

In step S411, the IPv6 session ID is released.

The technical solution according to the embodiment of the present invention has the following advantages: the IP session is filtered by checking whether the IP session ID generated according to the preset rules is added into the IP session, so that a coupling relation between a data communication process and an authentication process or an IP address configuration process of the IP session is established, and the security of the IP session is enhanced.

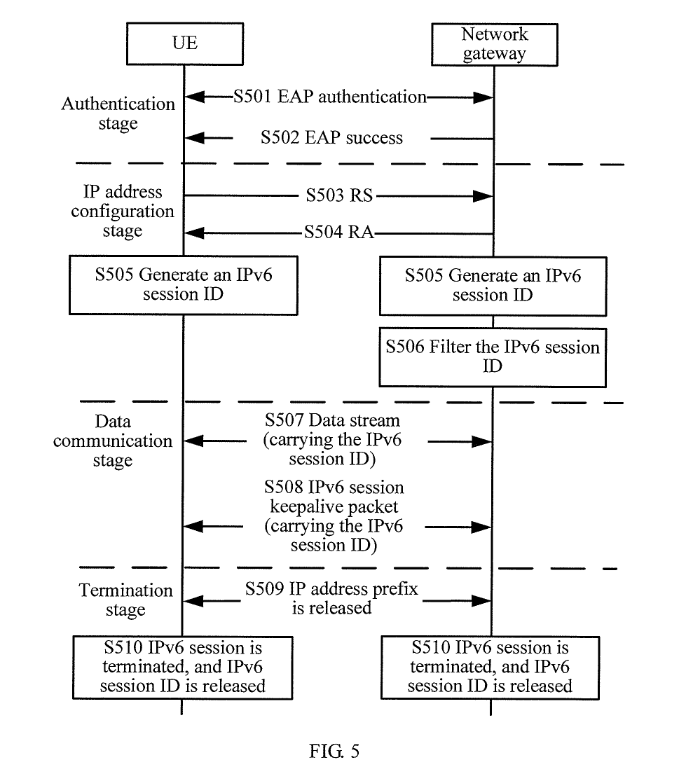

Corresponding to the technical solution of Embodiment 1 of the present invention, Embodiment 4 of the present invention provides another method for identifying an IP session in a dynamic IPv6 session, in which an IP session ID is created during an IP address configuration stage. FIG. 5 is a flow chart of the method. Referring to FIG. 5, the method includes the following steps:

In step S501, the UE performs the EAP authentication on the authentication server through the BNG.

In step S502, when the EAP authentication of the UE succeeds, an EAP Success message is sent to the UE by the authentication server through the BNG, and rules for generating an IPv6 session ID are configured in the UE.

In step S503, when the EAP authentication of the UE succeeds, the UE starts an SLAAC, and sends a Router Solicitation (RS) message to the BNG.

In step S504, after receiving the RS message, the BNG sends an RA message to the UE.

A source address of the RA message is an IPv6 address of the BNG, and the RA message includes an IPv6 address prefix.

In step S505, the BNG and the UE use the IPv6 address prefix carried by the RA message as the IPv6 session ID.

That is, the IPv6 address prefix and the IPv6 session are bound. Furthermore, the IPv6 session ID and the UE MAC address or the access port are bound, to form a binding relation table.

It should be noted that, if IPv6 address prefix renumbering is performed on the UE, it is considered that an old IP session is updated to a new IP session, and the IP session ID will be triggered by the new RA message and generated with the new IPv6 address prefix renumbering.

In step S506, the BNG filters the IPv6 session ID of the received IPv6 packet.

In step S507, the data communication is performed by using the data stream carrying the IPv6 session ID.

In the data communication stage, the IPv6 data packets all carry the IPv6 session ID generated according to the rules for generating an IPv6 session ID determined after the authentication succeeds.

In step S508, the data communication state keepalive monitoring is performed by using a keepalive packet carrying the IPv6 session ID.

The keepalive packets (for example, the BFD packets) of the IPv6 session all carry the IPv6 session ID generated according to the rules for generating an IPv6 session ID determined after the authentication succeeds.

It should be noted that, in a specific implementation environment, step S507 and step S508 have no certain sequence relation, and the change in the sequence of the two steps does not influence the protection scope of the present invention.

In step S509, the IPv6 address prefix is released or renumbered.

When the IPv6 address prefix is released or renumbered, it is considered that an old IP session is updated to a new IP session, that is, it is determined that the current IPv6 session is terminated.

In step S510, the IPv6 session ID is released.

The technical solution according to the embodiment of the present invention has the following advantages: the method for filtering the IP session is implemented by checking whether the IP session ID generated according to the preset rules is added into the IP session, so that a coupling relation between a data communication process and an authentication process or an IP address configuration process of the IP session is established, and the security of the IP session is enhanced.

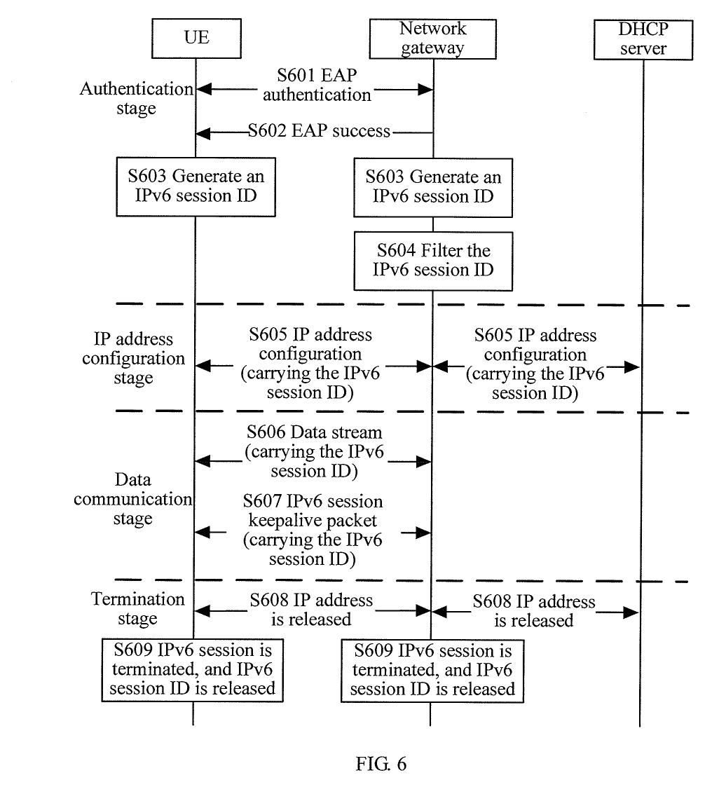

Corresponding to the technical solution of Embodiment 1 of the present invention, Embodiment 5 of the present invention provides another method for identifying an IP session in a dynamic IPv6 session, in which an IP session ID is created during an IP address configuration stage. FIG. 6 is a flow chart of the method. Referring to FIG. 6, the method includes the following steps:

In step S601, the UE performs the EAP authentication on the authentication server through the BNG.

In step S602, when the EAP authentication of the UE succeeds, an EAP Success message is sent to the UE by the authentication server through the BNG, and rules for generating an IPv6 session ID are configured in the UE.

In step S603, the BNG and the UE generate an IPv6 session ID for the BNG and the UE respectively according to the rules for generating an IPv6 session ID.

The BNG and the UE may generate the IPv6 session ID according to certain rules and according to the EAP Identifier of the EAP Success message; and if the PANA is adopted, the IPv6 session ID may also be generated according to certain rules and according to the PANA session ID.

In step S604, the BNG filters the IPv6 session ID of the received IPv6 packet.

In step S605, the UE requests an IPv6 address in a stateless or stateful address configuration manner.

During the IPv6 address configuration process, all uplink messages carry the IPv6 session ID generated according to the rules for generating IPv6 session ID determined after the authentication succeeds.

In step S606, the data communication is performed by using the data stream carrying the IPv6 session ID.

In the data communication stage, the IPv6 data packets carry the IPv6 session ID generated according to the rules for generating IPv6 session ID after the authentication succeeds.

In step S607, the data communication state keepalive is performed by using a keepalive packet carrying the IPv6 session ID.

The keepalive packets (for example, the BFD packets) of the IPv6 session all carry the IPv6 session ID generated according to the rules for generating IPv6 session ID determined after the authentication succeeds.

It should be noted that, in a specific implementation environment, step S606 and step S607 have no certain sequence relation, and the change in the sequence of the two steps does not influence the protection scope of the present invention.

In step S608, the IPv6 address is released.

In step S609, the IPv6 session is terminated, and the IPv6 session ID is released.

The technical solution according to the embodiment of the present invention has the following advantages: the method for filtering the IP session is implemented by checking whether the IP session ID generated according to the preset rules is added into the IP session, so that a coupling relation between a data communication process and an authentication process or an IP address configuration process of the IP session is established, and the security of the IP session is enhanced.

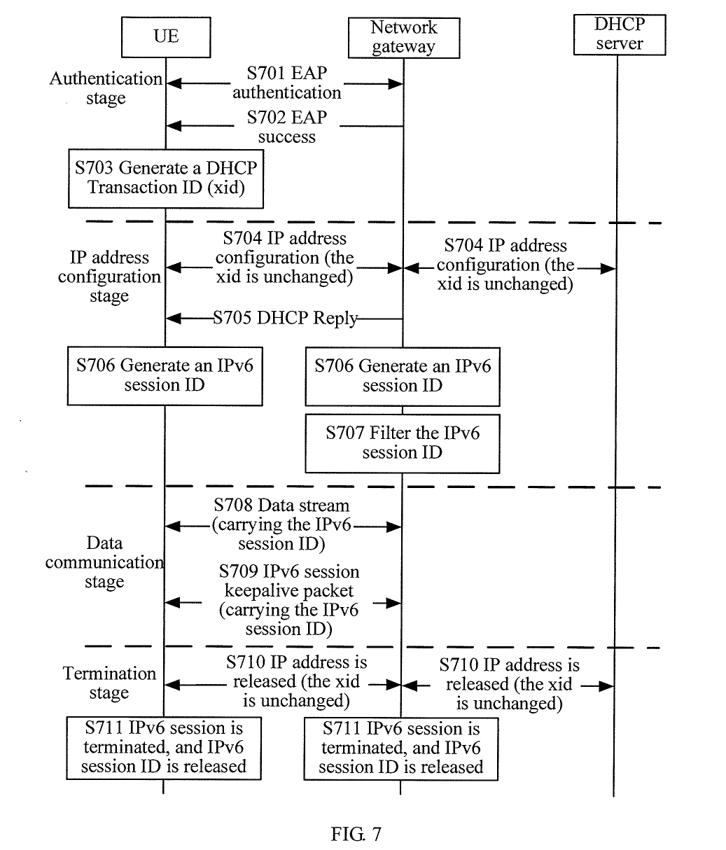

Corresponding to the technical solution of Embodiment 1 of the present invention, Embodiment 6 of the present invention provides another method for identifying an IP session in a dynamic IPv6 session, in which the IP session ID is created in an IP address configuration stage. FIG. 7 is a flow chart of the method. Referring to FIG. 7, the method includes the following steps:

In step S701, the UE performs the EAP authentication on the authentication server through the BNG.

In step S702, when the EAP authentication of the UE succeeds, an EAP Success message is sent to the UE by the authentication server through the BNG, and rules for generating an IPv6 session ID are configured in the UE.

In step S703, after the EAP authentication of the UE succeeds, the UE starts a stateful address configuration, and generates a DHCP Transaction ID (referred to as xid); the UE may generate the xid according to certain rules and according to an EAP Identifier of the EAP Success message; and if the PANA is adopted, the UE may generate the xid according to certain rules and according to a PANA session ID.

In step S704, the UE requests an IPv6 address through the stateful address configuration, and during the IPv6 address configuration process, the xid of all the DHCP messages remains unchanged.

It should be further noted that, as the session ID negotiation process like PPP is not carried out before the DHCP address configuration process, the xid is seemed as equivalent to the IP session ID, and it is suggested that the xid remains consistent in the life cycle of the same IP session; and if the IP address is changed through a reconfigure message in the DHCP process, it is considered that an old IP session is updated to a new IP session, and the xid will change with the new IP session.

In step S705, when the IPv6 address application succeeds, the DHCP server sends the IPv6 address to the UE through a DHCP Reply message.

In step S706, the BNG and the UE may generate an IPv6 session ID according to certain rules and according to the DHCP Transaction ID (xid) of the DHCP Reply message.

It should be further noted that, if the IP address is changed through a reconfigure/renew message in the DHCP process, it is considered that an old IP session is updated to a new IP session, and the IP session ID will be triggered by the new DHCP Reply message and generated with the new IP address renumbering.

In step S707, the BNG filters the IPv6 session ID of the received IPv6 packet.

In step S708, the data communication is performed by using the data stream carrying the IPv6 session ID.

In the data communication stage, the IPv6 data packets all carry the IPv6 session ID generated according to the rules for generating an IPv6 session ID determined after the authentication succeeds.

In step S709, the data communication state keepalive monitoring is performed by using a keepalive packet carrying the IPv6 session ID.

The keepalive packets (for example, the BFD packets) of the IPv6 session all carry the IPv6 session ID generated according to the rules for generating an IPv6 session ID determined after the authentication succeeds.

It should be noted that, in a specific implementation environment, step S708 and step S709 have no certain sequence relation, and the change in the sequence of the two steps does not influence the protection scope of the present invention.

In step S710, the IPv6 address is released.

In step S711, the IPv6 session is terminated, and the IPv6 session ID is released.

The technical solution according to the embodiment of the present invention has the following advantages: the method for filtering the IP session is implemented by checking whether the IP session ID generated according to the preset rules is added into the IP session, so that a coupling relation between a data communication process and an authentication process or an IP address configuration process of the IP session is established, and the security of the IP session is enhanced.

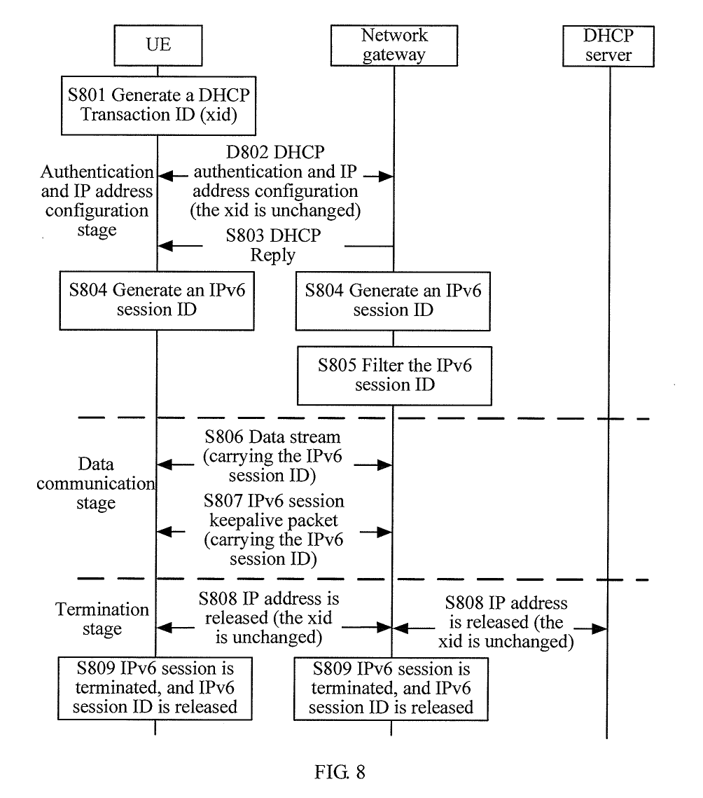

Corresponding to the technical solution of Embodiment 1 of the present invention, Embodiment 7 of the present invention provides another method for processing an IP session, in which the IP address configuration stage and the authentication stage are combined, and the IP session ID is created in this stage. FIG. 8 is a flow chart of the method. Referring to FIG. 8, the method includes the following steps.

In step S801, the UE generates a DHCP Transaction ID (referred to as xid).

In step S802, the UE implements the UE authentication and stateful address configuration through DHCP authentication, and in the DHCP authentication process, the xid of all the DHCP messages remains unchanged.

It should be further noted that, as the session ID negotiation process like PPP is not carried out before the DHCP address configuration process, the xid is seemed as equivalent to the IP session ID, and it is suggested that the xid remains consistent in the life cycle of the same IP session; and if the IP address is changed through a reconfigure/renew message in the DHCP process, it is considered that an old IP session is updated to a new IP session, and the xid will change with the new IP session

In step S803, when the DHCP authentication succeeds, the BNG sends the IPv6 address to the UE through a DHCP Reply message, to notify the UE that the authentication succeeds, and rules for generating the IPv6 session ID are configured in the UE.

It should be further noted that, if the IP address is changed through the reconfigure/renew message in the DHCP process, it is considered that an old IP session is updated to a new IP session, and the IP session ID will be triggered by the new DHCP Reply message and generated with the new IP address renumbering.

In step S804, the BNG and the UE may generate an IPv6 session ID according the rules for generating the IPv6 session ID determined after the authentication succeeds and according to the DHCP Transaction ID of the DHCP Reply message.

It should be further noted that, if the IP address is changed through the reconfigure/renew message in the DHCP process, it is considered that an old IP session is updated to a new IP session, and the IP session ID will be triggered by the new DHCP Reply message and generated with the new IP address renumbering.

In step S805, the BNG filters the IPv6 session ID of the received IPv6 packet.

In step S806, the data communication is performed by using the data stream carrying the IPv6 session ID.

In the data communication stage, the IPv6 data packets all carry the IPv6 session ID generated according to the rules for generating IPv6 session ID determined after the authentication succeeds.

In step S807, the data communication state keepalive monitoring is performed by using a keepalive packet carrying the IPv6 session ID.

The keepalive packets (for example, the BFD packets) of the IPv6 session all carry the IPv6 session ID generated according to the rules for generating an IPv6 session ID determined after the authentication succeeds.

It should be noted that, in a specific implementation environment, step S806 and step S807 have no certain sequence relation, and the change in the sequence of the two steps does not influence the protection scope of the present invention.

In step S808, the IPv6address is released.

In step S809, the IPv6 session is terminated, and the IPv6 session ID is released.

The technical solution according to the embodiment of the present invention has the following advantages: the method for filtering the IP session is implemented by checking whether the IP session ID generated according to the preset rules is added into the IP session, so that a coupling relation between a data communication process and an authentication process or an IP address configuration process of the IP session is established, and the security of the IP session is enhanced.

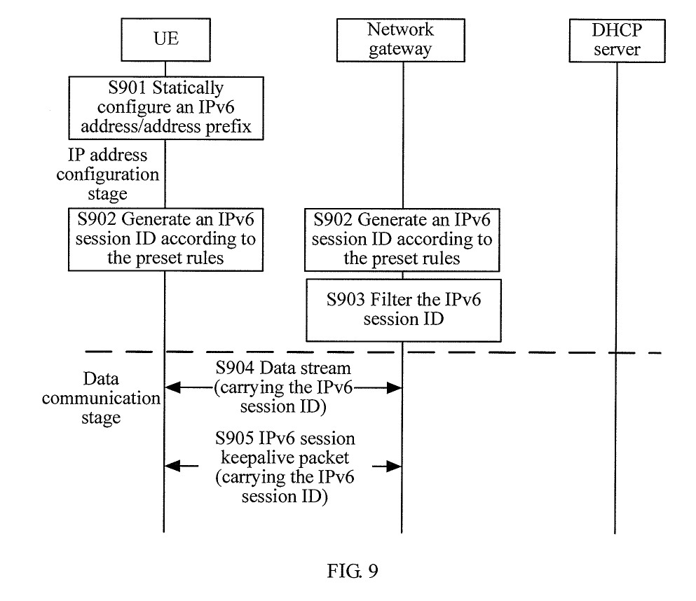

Corresponding to the technical solution of Embodiment 1 of the present invention, Embodiment 8 of the present invention provides a method for processing an IP session in a static IPv6 session, in which as the IP session is a static IP session, the authentication stage does not exist, only the IP address configuration stage exists, and the IP session ID is created in this stage. FIG. 9 is a flow chart of the method. Referring to FIG. 9, the method includes the following steps.

In step S901, a network statically configures an IPv6 address/address prefix of the UE and rules for generating an IPv6 session ID.

In step S902, the BNG and the UE generate an IPv6 session ID according to the preset rules for generating the IPv6 session ID and according to the IPv6 address/address prefix of the UE.

In step S903, the BNG filters the received IPv6 packet according to the IPv6 session ID.

In step S904, the data communication is performed by using the data stream carrying the IPv6 session ID.

In the data communication stage, the IPv6 data packets all carry the IPv6 session ID generated according to the rules for generating an IPv6 session ID determined after the authentication succeeds.

In step S905, the data communication state keepalive monitoring is performed by using a keepalive packet carrying the IPv6 session ID.

The keepalive packets (for example, the BFD packets) of the IPv6 session all carry the IPv6 session ID generated according to the rules for generating the IPv6 session ID determined after the authentication succeeds.

It should be noted that, in a specific implementation environment, step S904 and step S905 have no certain sequence relation, and the change in the sequence of the two steps does not influence the protection scope of the present invention.

The technical solution according to the embodiment of the present invention has the following advantages: the method for filtering the IP session is implemented by checking whether the IP session ID generated according to the preset rules is added into the IP session, so that a coupling relation between a data communication process and an authentication process or an IP address configuration process of the IP session is established, and the security of the IP session is enhanced.

Through the above description of the above embodiments, it is clear to persons skilled in the art that the present invention may be accomplished through hardware, or through software plus a necessary universal hardware platform. Based on this, the technical solutions of the present invention may be embodied in the form of a software product. The software product may be stored in one or more nonvolatile storage media (for example, CD-ROM, USB flash drive, or removable hard disk) and contain several instructions configured to instruct computer equipment (for example, a personal computer, a server, or network equipment) to perform the method according to the embodiments of the present invention.

It should be understood by persons skilled in the art that the accompanying drawings are merely schematic diagrams of a preferred embodiment, and modules or processes in the accompanying drawings are not necessarily required to implement the present invention.

Exemplary embodiments of the present invention are described. It should be noted by persons of ordinary skill in the art that modifications and variations may be made without departing from the principle of the present invention, which should be construed as falling within the protection scope of the present invention.

What is claimed is:

1. A method for identifying an Internet Protocol (IP), session, the method comprising:
generating an IP session identity (ID), for an IP session during an IP address configuration process for a User Equipment (UE), according to preset rules for generating the IP session ID; and
filtering a received IP session packet from the UE according to the IP session ID.

2. The method for identifying an IP session according to claim 1, wherein the filtering the received IP session packet from the UE according to the IP session ID comprises:
determining whether the IP session ID and a Media Access Control, MAC, address or an access port of the UE are consistent with a preset binding relation table;
if the IP session ID and the MAC address or the access port of the UE are consistent with the preset binding relation table, permitting the IP session packet to pass; if the IP session ID and the MAC address or the access port of the UE are not consistent with the preset binding relation table, discarding the IP session packet.

3. The method for identifying an IP session according to claim 2, before the step of filtering a received IP session packet from the UE according to the IP session ID, further comprising:
authorizing the IP session according to the IP session ID, if the IP session ID is carried in an Authentication, Authorization and Accounting (AAA), message of the IP session.

4. The method for identifying an IP session according to claim 2, wherein before the generating the IP session ID for the IP session during the IP address configuration process according to the preset rules for generating the IP session ID, the method further comprises a step of setting the rules for generating the IP session ID:
setting the rules for generating the IP session ID, and setting the rules for generating the IP session ID in the UE by sending an address configuration response message to the UE.

5. The method for identifying an IP session according to claim 3, wherein before the generating the IP session ID for the IP session during the IP address configuration process according to the preset rules for generating the IP session ID, the method further comprises a step of setting the rules for generating the IP session ID:
setting the rules for generating the IP session ID locally when the IP session is a dynamic IP session, and setting the rules for generating the IP session ID in the UE by sending an address configuration response message to the UE.

6. The method for identifying an IP session according to claim 4, wherein the generating the IP session ID for the IP session during the IP address configuration process according to the preset rules for generating the IP session ID comprises:
generating the IP session ID for the IP session during the IP address configuration process according to the preset rules for generating the IP session ID and an IP session address prefix obtained through address configuration Prefix Delegation (PD).

7. The method for identifying an IP session according to claim 2, wherein the IP session ID is an IP address prefix of the IP session packet.

8. The method for identifying an IP session according to claim 3, wherein the IP session ID is an IP address prefix of the IP session packet.

9. The method for identifying an IP session according to claim 7, wherein the method further comprises:
releasing the IP session ID when the IP session address prefix is released or renumbered.

10. A network gateway, comprising:
a generating module, configured to generate an Internet Protocol (IP) session identity (ID) for an IP session during an IP address configuration process for a User Equipment (UE), according to preset rules for generating the IP session ID; and
a processing module, configured to filter a received IP session packet from the UE according to the IP session ID.

11. The network gateway according to claim 10, wherein the processing module comprises:
a determining sub-module, configured to determine whether the IP session ID and a Media Access Control (MAC), address or an access port of the UE, are consistent with a preset binding relation table; and
a filtering sub-module, configured to permit the packet to pass, if the determining sub-module determines that the IP session ID and the MAC address or the access port of the UE are consistent with the preset binding relation table; and discard the packet, if the determining sub-module determines that the IP session ID and the MAC address or the access port of the UE are not consistent with the preset binding relation table.

12. The network gateway according to claim 10, further comprising:
a setting module, configured to locally set the rules for generating the IP session ID and the binding relation table; and
a sending module, configured to send the rules for generating the IP session ID set by the setting module to the UE.

13. The network gateway according to claim 11, further comprising:
a setting module, configured to locally set the rules for generating the IP session ID and the binding relation table; and
a sending module, configured to send the rules for generating the IP session ID set by the setting module to the UE.

14. The network gateway according to claim 11, wherein the generating module comprises:
an obtaining sub-module, configured to obtain an IP session address prefix through address configuration Prefix Delegation (PD); and
a generating sub-module, configured to generate the IP session ID for the IP session according to the IP session address prefix.

15. The network gateway according to claim 13, wherein the generating module comprises:
an obtaining sub-module, configured to obtain an IP session address prefix through address configuration Prefix Delegation (PD); and
a generating sub-module, configured to generate the IP session ID for the IP session according to the IP session address prefix.

16. A system for processing an IP session, the system comprising a User Equipment (UE) and a network gateway, wherein
the UE is configured to receive rules for generating an Internet Protocol (IP) session identity (ID) sent by the network gateway, generate the corresponding IP session ID according to the rules for generating the IP session ID, and send an IP session packet to the network gateway; and
the network gateway is configured to set the rules for generating the IP session ID, send the rules for generating the IP session ID to the UE, generate the IP session ID for an IP session during an IP address configuration process for the UE according to the rules for generating the IP session ID, and filter the IP session packet from the UE according to the IP session ID.

17. The system for processing an IP session according to claim 16, wherein the network gateway is further configured to:
determine whether the IP session ID and a Media Access Control (MAC), address or an access port of the UE are consistent with a preset binding relation table; if the IP session ID and the MAC address or the access port of the UE are consistent with the preset binding relation table, permit the IP session packet to pass; if the IP session ID and the MAC address or the access port of the UE are not consistent with the preset binding relation table, discard the IP session packet.

18. The system for processing an IP session according to claim 17, wherein the network gateway is further configured to:
authorize the IP session according to the IP session ID, if the IP session ID is carried in an Authentication, Authorization and Accounting (AAA), message of the IP session.

19. The system for processing an IP session according to claim 17, wherein the network gateway is further configured to:
set the rules for generating the IP session ID locally when the IP session is a dynamic IP session, and set the rules for generating the IP session ID in the UE by sending an address configuration response message to the UE.

20. The system for processing an IP session according to claim 19, wherein the network gateway is further configured to:
generate the IP session ID for the IP session during the IP address configuration process according to the preset rules for generating the IP session ID and an IP session address prefix obtained through address configuration Prefix Delegation (PD).
